(19) United States
(12) Patent Application Publication
(10) Pub. No.: US 2006/0198553 A1
(43) Pub. Date: Sep. 7, 2006

(54) Digital flat detector for detecting x-radiation

(76) Inventors: Volker Heer, Gundelsheim (DE); Mathias Hoernig, Erlangen (DE); Bernhard Sandkamp, Erlangen (DE)

Correspondence Address: HARNESS, DICKEY & PIERCE, P.L.C., P.O.BOX 8910, RESTON, VA, 20195, US

(21) Appl. No.: 11/354,163

(22) Filed: Feb. 15, 2006

(30) Foreign Application Priority Data
Feb. 16, 2005 (DE) 10 2005 007 094.9

(51) Int. Cl. G06K 9/00

(52) U.S. Cl. 382/130

(57) ABSTRACT

To protect a digital flat detector, especially a mobile detector, against being damaged by the effect of impact, an automatically triggering device is provided. The automatically triggering device, including an airbag for example, is provided for protection against the effect of external mechanical impact.

The present application hereby claims priority under 35 U.S.C. §119 on German patent application number DE 10 2005 007 094.9 filed Feb. 16, 2005, the entire contents of which is hereby incorporated herein by reference.

### FIELD

The invention generally relates to a digital flat detector for detecting x-radiation.

### BACKGROUND

Flat detectors are known, for example, from the article “Flachbilddetektoren in der Röntgendiagnostik” [flat image detectors in radio diagnostics] by M. Spahn, V. Heer, R Freytag, published in the journal Radiologe 43, 2004, pages 340 to 350.

On account of their complex construction and their numerous electrical components and circuits for driving the active detector surface and for reading out x-ray images, digital flat detectors of this type are generally complex and very expensive. To provide flexible use in different x-ray systems, digital flat detectors are increasingly also being designed as mobile appliances. Especially in this case, there is the risk of a flat detector accidentally fallen down or being damaged by collisions with hard objects.

### SUMMARY

An object of at least one embodiment of the present invention is to be able to avoid damage to digital flat detectors by the effect of impact in a simple and reliable way.

An object may be achieved according to at least one embodiment of the invention in the case of a digital flat detector for detecting x-radiation.

The device provided according to at least one embodiment of the invention for protection against the effect of external mechanical impact and the automatic triggering of this protective device allows the flat detector to be protected in a simple and effective manner against damage or even complete destruction in a case where it is at risk from the effect of impact, such as for example as a result of falling down and collisions, a protective device of this type additionally being compact and able to be fitted without great effort—if appropriate even merely by retrofitting.

According to a refinement of at least one embodiment of the invention, the device for providing protection against the effect of external mechanical impact includes at least one expandable airbag. Since it is very small in the non-expanded state, this airbag, which is made to expand explosively in the event of imminent risk, can be easily fitted on the housing of the flat detector without making it much larger or restricting its operational use. By its expandable cushion, the airbag prevents a collision of the flat detector with the ground or other hard objects especially effectively.

In a way that is advantageous for protecting the flat detector from all sides, at least one airbag is formed in the manner of an impact guard enclosing the flat detector on all sides.

According to a further refinement of at least one embodiment of the invention, the device comprises at least one acceleration sensor for measuring the acceleration of the flat detector. Acceleration occurs in particular when the flat detector falls down. In an advantageous way, triggering of the expansion of the airbag is dependent on the exceeding of a predeterminable threshold value of the acceleration of the flat detector, to which the flat detector is subjected prior to the impact effect.

An acceleration threshold value of this type can be calculated on the basis of the weight of the flat detector and a minimum drop height of, for example, 50 cm. The expansion of the airbag when the threshold value is exceeded ensures that protection of the flat detector only occurs when the flat detector is actually at risk as a result of falling down.

According to a further refinement of at least one embodiment of the invention, the device comprises at least one sensor for measuring a deviation from a defined position of the flat detector prior to the impact effect. In an advantageous way for protection against damage to the flat detector in the event of lateral movement or slipping, triggering of the expansion of the airbag is dependent on the exceeding of a predeterminable threshold value of the deviation from a defined position of the flat detector.

An especially advantageous application of at least one embodiment of the invention is given in particular by a flat detector in the form of a mobile flat detector, since the risk of falling down or collision is then especially great.

### BRIEF DESCRIPTION OF THE DRAWINGS

Embodiments of the invention and further advantageous refinements are explained in more detail below on the basis of the detailed description and on the basis of example embodiments schematically represented in the drawings, without thereby restricting the invention to these example embodiments; in the drawings:

FIG. 1 shows in side view a flat detector according to at least one embodiment of the invention with an airbag at the edge, in the non-expanded state;

FIG. 2 shows in plan view a flat detector according to at least one embodiment of the invention with an airbag at the edge, in the expanded state;

FIG. 3 shows in side view a section through a flat detector according to FIG. 2.

### DETAILED DESCRIPTION OF THE EXAMPLE EMBODIMENTS

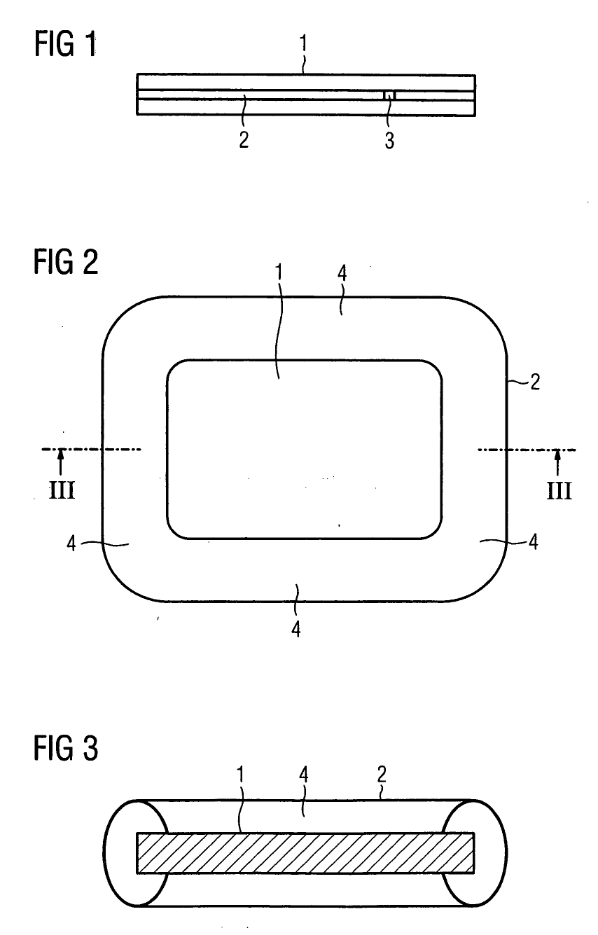

FIG. 1 shows a digital flat detector 1 in side view, with a device arranged on its sides for protection against the effect of external mechanical impact in the form of an airbag 2, in the non-expanded state. The device or the airbag 2 is provided in an advantageous way on the outer edge of the flat detector, for example on the housing part of the flat detector 1. The airbag 2 takes up only little overall space and can easily be fitted, so that it only makes the flat detector 1 insignificantly larger and the operational function is not restricted. For the expansion of the airbag 2, integrated on the airbag 2 as a triggering mechanism is an inflator 3, which by analogy with the technique known in vehicles causes explosive inflation of the airbag 2 and thereby creates a protective air cushion. It is also possible for a number of airbags to be provided, for example an airbag may be fitted on each outer side of the flat detector 1.

Likewise integrated in the flat detector 1 is at least one acceleration sensor—not represented here; a number of acceleration sensors are also provided with preference. Predetermined for each flat detector is a threshold value for the acceleration, which can be calculated for example on the basis of the weight of the flat detector and a minimum drop height. If the flat detector exceeds this acceleration threshold value, a triggering signal is sent to the inflator 3 and triggers the airbag. The triggering signal may be produced for example by the closing of an electrical contact by means of a switch. The reaction time of commercially available airbags is about 0.04 seconds, so that protection is possible even in the case of small heights.

FIGS. 2 and 3 show the flat detector 1 with an expanded airbag 2 with air cushions 4. It can be seen that the air cushions 4 surround the flat detector 1 in such a way that, if for example it falls down onto the floor, there is no direct impact but instead the flat detector 1 just lands harmlessly on the floor with a cushioned effect. A flat detector 1 is generally at risk especially when it is being installed or removed and transported or in the case of a mobile flat detector 1.

In addition or as an alternative to the acceleration sensor, it is also possible to provide at least one sensor for measuring a change in the distance from a defined position of the flat detector 1 prior to the impact effect. A sensor of this type measures the deflection of the flat detector 1 corresponding to the change in distance and may take the form of a strip that can be unwound. The strip is contained for example in a holder of an x-ray device assigned to the flat detector 1. By analogy with the acceleration sensor, the airbag 2 is made to expand when a predefined threshold value for the deflection of the strip is reached, in order to prevent a collision of the flat detector 1 with hard objects causing damage to the flat detector 1.

Because it is simple to fit, after use the airbag 2 can easily be replaced by a new airbag.

At least one example embodiment of the invention can be summarized as follows: to protect a digital flat detector 1, especially a mobile detector, against being damaged by the effect of impact, an automatically triggering device is provided for protection against the effect of external mechanical impact, especially in the form of an airbag 2.

What is claimed is:

1. A digital flat detector for detecting x-radiation, comprising:
an automatically triggerable device to provide protection against an effect of external mechanical impact.

2. The flat detector as claimed in claim 1, wherein the automatically triggerable device includes at least one expandable airbag.

3. The flat detector as claimed in claim 2, wherein the at least one airbag is formed in the manner of an impact guard enclosing the flat detector on all sides.

4. The flat detector as claimed in claim 3, wherein the automatically triggerable device is provided on an outer edge of the flat detector.

5. The flat detector as claimed in claim 1, wherein the automatically triggerable device includes at least one acceleration sensor to measure acceleration to which the flat detector is subjected prior to the impact effect.

6. The flat detector as claimed in claim 2, wherein triggering of the expansion of the airbag is dependent on exceeding a predeterminable threshold value of acceleration of the flat detector.

7. The flat detector as claimed in claim 1, wherein the automatically triggerable device includes at least one sensor for measuring a deviation from a defined position of the flat detector prior to the impact effect.

8. The flat detector as claimed in claim 2, wherein triggering of the expansion of the airbag is dependent on exceeding a predeterminable threshold value of the deviation from a defined position of the flat detector.

9. The flat detector as claimed in claim 1, wherein an airbag and a triggering mechanism, that is dependent on a sensor, are structurally integrated on a lateral surround of the flat detector.

10. The flat detector as claimed in claim 1, wherein the flat detector is a mobile flat detector.

11. The flat detector as claimed in claim 5, wherein triggering of the expansion of the airbag is dependent on exceeding a predeterminable threshold value of acceleration of the flat detector.

12. The flat detector as claimed in claim 7, wherein triggering of the expansion of the airbag is dependent on exceeding a predeterminable threshold value of the deviation from a defined position of the flat detector.

13. A digital flat detector for detecting x-radiation, comprising:
at least one expandable airbag; and
means for automatically triggering expansion of the airbag, upon the flat detector exceeding a predeterminable threshold value of acceleration of the flat detector, to provide protection against an effect of external mechanical impact.

14. The flat detector as claimed in claim 13, wherein the at least one airbag is formed in the manner of an impact guard enclosing the flat detector on all sides.

15. The flat detector as claimed in claim 13, wherein means for automatically triggering is provided on an outer edge of the flat detector.

16. The flat detector as claimed in claim 13, wherein the means for automatically triggering includes at least one acceleration sensor to measure acceleration to which the flat detector is subjected prior to the impact effect.

17. A digital flat detector for detecting x-radiation, comprising:
at least one expandable airbag; and
means for automatically triggering expansion of the airbag, upon the flat detector exceeding a predeterminable threshold value of a deviation from a defined position of the flat detector, to provide protection against an effect of external mechanical impact.

18. The flat detector as claimed in claim 17, wherein the the means for automatically triggering includes at least one sensor for measuring the deviation from a defined position of the flat detector prior to the impact effect.
